(19) United States
(12) Patent Application Publication
(10) Pub. No.: US 2023/0220173 A1
(43) Pub. Date: Jul. 13, 2023

(54) MATTER-REPELLENT SLIPPERY COATINGS AND MANUFACTURE THEREOF

(71) Applicant: The University of Hong Kong, Hong Kong (CN)

(72) Inventors: Liqiu WANG, Hong Kong (CN); Jiaqian LI, Hong Kong (CN)

(21) Appl. No.: 18/069,403

(22) Filed: Dec. 21, 2022

Related U.S. Application Data
(60) Provisional application No. 63/266,668, filed on Jan. 11, 2022.

(51) Int. Cl. C08J 7/04; C08L 27/18; C09D 7/40; C09D 7/65; C09K 3/18

(52) U.S. Cl. CPC C08J 7/0427; C08L 27/18; C09D 7/66; C09D 7/65; C09K 3/18; C08L 2205/18; C08L 2205/22

(57) ABSTRACT

A matter-repellent colloid-infused smooth surface (CISS) device has a solid substrate with a smooth surface where a thin coating of a non-volatile lubricating fluid and a plurality of nanoparticles and/or microparticles reside on the surface. The non-volatile lubricating fluid can be a perfluorinated fluid and the nanoparticles and/or microparticles can be polytetrafluoroethylene (PTFE) to provide a slippery surface to a metal, ceramic, glass, or plastic substrate. As needed, the smooth surface of the substrate can be modified with a silylating agent that is miscible with the lubricating fluid to enhance the stability of the coating smooth surface interface. In this manner, tubes, catheters, vials, bottles, or other devices can be imparted with a slippery surface that repels most gases, liquids, and solids.

### CROSS-REFERENCE TO RELATED APPLICATION

This application claims the benefit of U.S. Provisional Application Ser. No. 63/266,668, filed Jan. 11, 2022, which is hereby incorporated by reference in its entirety including any tables, figures, or drawings.

### BACKGROUND OF THE INVENTION

The most cutting-edge approaches to create synthetic liquid-repellent surfaces are currently inspired by the lotus leaf and Nepenthes pitcher plant. The lotus leaf approach aims to develop superhydrophobic surfaces by using hierarchical structures to trap the air inside that enables water droplets to roll off quickly. The Nepenthes pitcher plant approach is to manufacture slippery liquid-infused porous surfaces (SLIPS) that harness structural roughness to entrench a stable lubricant film to make immiscible droplets slip off easily. Both lotus leaf and Nepenthes pitcher plant type structure-dependent repellent surfaces have been widely proven to be promising platforms in a diversity of applications including self-cleaning, anti-icing, anti-fouling, anti-adhesion, fluidic navigation, water harvesting and heat transfer. Despite their different underlying repellency mechanisms, both depend on surface structures to stably fix air or oil inside to repel fluids. The introduction of surface structures, while being the prevailing approach to date, suffers from inherent limitations, such as physical stability, manufacturing difficulties in enclosed spaces, large-scale feasibility, and function damage or modification to smooth materials, which severely restricts the applicability of these liquid-repellent surfaces. In addition, these surface structures can enhance the adhesion of vapor and solid foulants to these engineered surfaces, thereby compromising their repellency to matter foulants with different states. For example, superhydrophobic surfaces can effectively repel water droplets in liquid phase but are easily fouled by gas bubbles and solid ice, while SLIPS are effective in repelling bubbles and fluids but fail to work for viscoelastic solids. Synergistic contamination of multiple states of matter is common in numerous real-world applications, while surface design or coating strategy that can simultaneously repel the solid, liquid and vapor accumulation remains rare. This long-standing challenge and the ability to employ smooth surfaces are addressed herein.

### BRIEF SUMMARY OF THE INVENTION

Embodiments of the invention are directed to a colloid-infused smooth surface (CISS) device where a solid substrate with a smooth surface has a thin coating of a non-volatile lubricating fluid and a plurality of nanoparticles and/or microparticles. The non-volatile lubricating fluid can be a perfluorinated fluid, such as, but not limited to perfluorotripentylamine (FC-70) and Krytox™ oils. The non-volatile lubricating fluid can be other liquids, such as silicone oils, mineral oils, ferrofluid, ionic liquid, polyalphaolefin oils, and hydroxy-terminated polydimethylsiloxanes for CISS surfaces that can be paired to repelling of liquids and solids that are immiscible with the liquid and particles that have a high affinity to the non-volatile lubricating fluid over any material to be repelled. The nanoparticles and/or microparticles can be polytetrafluoroethylene (PTFE), silica, titanium oxide, silver, and graphene. The surface of the nanoparticles and/or microparticles can be treated with a silylating agent, a functional trialkoxylsilane, where the functional group provides a particle's surface with affinity to the lubricating fluid but not the liquid to be repelled. The CISS surface is repellant to all fluids that are not miscible with the lubricating fluid. The solid substrate can be a metal, ceramic, glass, or plastic with a smooth surface that can have a roughness factor from 1.00 to 1.45. The smooth surface can be silylated with a silylating agent miscible with the lubricating fluid. For example, when the fluid is FC-70 or Krytox™ oils, the silylating agent can be, for example, 1H,1H,2H,2H-perfluorodecyltrichlorosilane or any other surface reactive fluorocarbon silane.

Another embodiment is directed to a method of forming a solid device with a CISS that repels gases, liquids, and solids, where a solid object having a smooth surface undergoes coating of the smooth surface with a colloidal suspension that includes a non-volatile lubricating fluid and a plurality of nanoparticles and/or microparticles. The solid object can be a metal, ceramic, glass, or plastic. Non-limiting devices can be tubes, vials, and bottles, but can be any object where a need for repelling mass is desirable. The solid object can be coated by dip coating, roll coating, spraying, or any other method. The non-volatile lubricating fluid can be a perfluorinated fluid that can repel a wide variety of gases, liquids, and solids, such as, but not limited to hydrocarbons, mineral oil, water, ethanol, silicone oils, glycerol, ethylene glycol, dimethylformamide, honey, ketchup, toothpaste, and peanut butter. The perfluorinated fluid is selected from FC-70 and Chemours™ Krytox™ oils and the nanoparticles and/or microparticles can be polytetrafluoroethylene (PTFE). The smooth surfaces of the substrate can be silylated with a silylating agent miscible with the lubricating fluid. For example, but not limited to 1H,1H,2H,2H-perfluorodecyltrichlorosilane when the lubricating fluid is a perfluorinated fluid.

### BRIEF DESCRIPTION OF THE DRAWINGS

FIG. 1A shows a schematic drawing of a colloid-infused smooth surface (CISS) that includes a colloid film with a lubricant oil and particles on a physically smooth surface.

FIG. 1B is an optical photograph showing the stability of the colloid where the top layer is dyed ethanol and bottom layer is a colloid of FC-70 oil and PTFE microparticles, with a scale bar, 1 cm.

FIG. 1C is a transmission electron micrograph of PTFE microparticles in the colloid with a mass fraction of ϕ=0.02, with a scale bar of 1 μm.

FIG. 1D shows a scanning electron micrograph showing the particle-induced rough surface, where the scale bar is 500 nm.

FIG. 1E shows schematic drawings (top) and time-lapse optical photographs of the CISS on smooth silylated Al sheets and untreated Si Al sheets where the Scale bar is 1 cm.

FIG. 2A Time-dependent optical photographs showing the lossless mobility of a low-surface-tension hexane droplet (˜4.2 μl) sliding on a CISS at a low tilting angle α≈3.0°, where the Scale bar is 1 mm.

FIG. 2B is a plot of contact angle hysteresis as a function of surface tension of repelled liquids on CISS. CISS 1, 2 and 3 refer to the slippery surfaces made on smooth aluminum, stainless steel, and PTFE, respectively.

FIG. 2C is a plot of the sliding angles on CISS for Newtonian fluids, non-Newtonian fluids, and viscoelastic solid peanut butter where the first dotted line separates Newtonian from non-Newtonian fluids and the second dotted line separates the viscosity that is considered the break between liquid and solid repellency.

FIG. 2D shows a schematic drawing and time-sequence optical photographs of the repellency of CISS to peanut butter where initial mobility of a piece of peanut butter occurs on an inclined CISS at α≈15°, where the scale bar is 1 cm.

FIG. 2E shows a schematic drawing and time-sequence optical photographs of the pinning of peanut butter on superhydrophobic surface with the pinning of a piece of peanut butter is retained on a superhydrophobic surface inclined at α≈80°, where the scale bar is 1 cm.

FIG. 2F shows a schematic and time-sequence optical photographs showing the pinning of peanut butter on a slippery liquid-infused porous surfaces (SLIPS) where the pinning of a piece of peanut butter is retained on a SLIPS inclined at α≈80° and where the scale bar is 1 cm.

FIG. 2G shows a schematic and time-sequence optical photographs showing the pinning of peanut butter on a smooth plate of aluminum where the pinning of a piece of peanut butter is retained on a smooth plate inclined at α≈80° and where the scale bar is 1 cm.

FIG. 2H shows a schematic drawing (top) and time-sequence optical photographs of bubble repellency of CISS and smooth surface where the middle panels present optical photographs of a gas bubble (˜30 μl) sliding up on an inclined CISS at α≈2.5° and the bottom panels present optical photographs of a gas bubble pinning on an inclined smooth Al? surface at a 2.5° where the scale bar is 5 mm.

FIG. 3A is a plot of the of the sliding angles of water, mineral oil, and hexadecane droplets on a series of CISS with different mass fractions of particles.

FIG. 3B A plot showing the dissipative forces acting on moving water, mineral oil and hexadecane droplets on a series of CISS with different mass fractions of particles.

FIG. 3C is a plot of dissipative forces F_{d} acting on moving droplets on various CISS where experimental values are plotted over a theoretical line for fluid droplets (water, mineral oil and hexadecane) with volumes 1-10 μl moving at 0.1-5 mm/s on different CISSs infused by the colloids with different mass fractions ϕ=0.006-0.08.

FIG. 3D shows composite plots of sliding angle as a function of the number of impacting droplets for CISS and SLIPS samples with continuous droplet impact, where the inset plot presents the results of water droplets impacting on the smooth surface covered by neat FC-70 oil (ϕ=0.0), and the inset photograph presents the pinning behavior of the water droplet (˜5 μl) on the neat FC-70 oil covered surface after the impact of five droplets.

FIG. 3E shows a composite of the contact angle hysteresis for CISSs of various mass fraction of particles for water, mineral oil, and hexadecane.

FIG. 4A shows the sliding angle on various and CISSs with various smooth surfaces of various metals, silicon, ceramics, and plastics displaying similar repellency of mineral oil, water, tomato ketchup, and peanut butter.

FIG. 4B shows time lapse photographic images of the anti-adhesion of tomato ketchup on the slippery CISS glass vial with a scale bar of 1 cm.

FIG. 4C shows time lapse photographic images of the strong adhesion of tomato ketchup in the smooth glass vial with a scale bar of 1 cm.

FIG. 4D shows time lapse photographic images of the anti-adhesion of honey on the slippery CISS glass vial with a scale bar of 1 cm.

FIG. 4E shows time lapse photographic images of the strong adhesion of honey in the smooth glass vial with a scale bar of 1 cm.

FIG. 4F shows time lapse photographic images of the anti-adhesion of yogurt on the slippery CISS glass vial with a scale bar of 1 cm.

FIG. 4G shows time lapse photographic images of the strong adhesion of yogurt in the smooth glass vial with a scale bar of 1 cm.

FIG. 4H shows a bar graph for the residue fraction of ketchup, honey, and yogurt on the surface of slippery CISS and smooth vials.

FIG. 4I shows time-dependent photographs of a mineral oil droplet (˜5 μl) sliding on the exterior of an inclined slippery catheter at α≈5.0° with a scale bar of 2 mm.

FIG. 4J shows time-dependent photographs of a mineral oil droplet (˜5 μl) without sliding on the exterior of an inclined smooth catheter at α≈5.0° with a scale bar of 2 mm.

FIG. 4K shows time-dependent optical photographs of a mineral oil slug (˜3.5 μl) sliding inside an inclined slippery catheter at α≈5.0° with a scale bar of 2 mm.

FIG. 4L shows time-dependent optical photographs of a mineral oil slug (˜3.5 μl) without sliding inside an inclined smooth catheter at α≈5.0° with a scale bar of 2 mm.

FIG. 5 shows a series of photographs over 106 seconds where drops of dyed water are applied to a smooth plate and an equivalent smooth plate with a CISS surface, frozen, and tilted to 10 degrees after one minute, where the ice is fixed to the smooth surface and the slides on the CISS surface.

FIG. 6. illustrates the rolling of a water drop on 5° inclined CISS, left, SLIPS, and SHS surfaces where the CISS surface displays a damage repaired surface in contrast to the SLIPS and SHS surfaces.

FIG. 7. shows a plot of the sliding angle on a CISS surface for water drops of various pH values.

FIG. 8. shows a plot of the sliding angle on a CISS surface for water drops after immersion of samples with CISS surfaces after immersion in NaOH and HCl solutions for periods up to ten days.

FIG. 9. shows a plot of the change in the sliding angle on a CISS surface and a SLIPS surface after repeated impacting of drops on the surface.

FIG. 10. shows a plot of the sliding angle for CISS surfaces over time for a relatively volatile FC-70 oil used to form the colloid and for two relatively non-volatile Krytox™ oils.

### DETAILED DISCLOSURE OF THE INVENTION

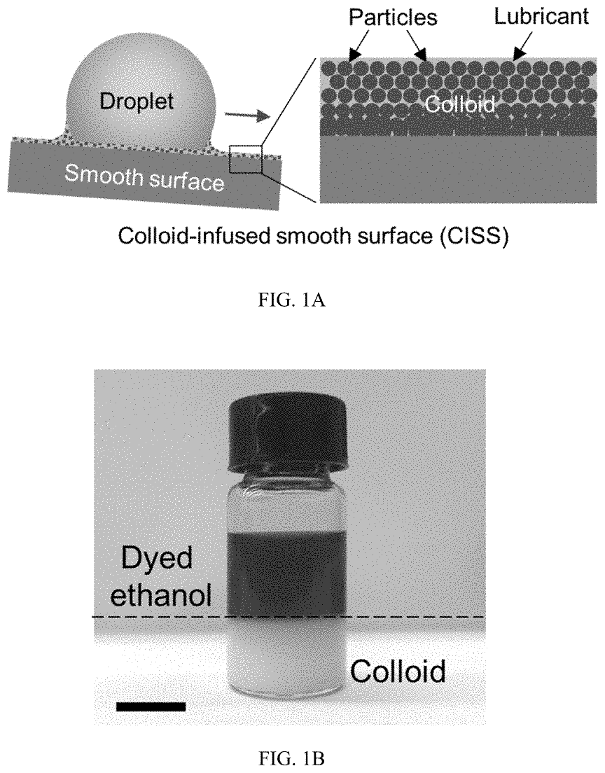

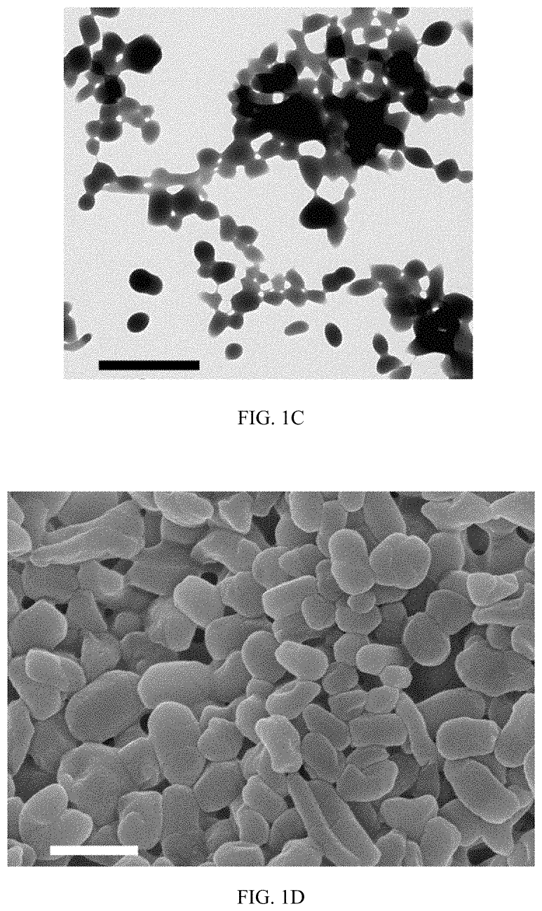

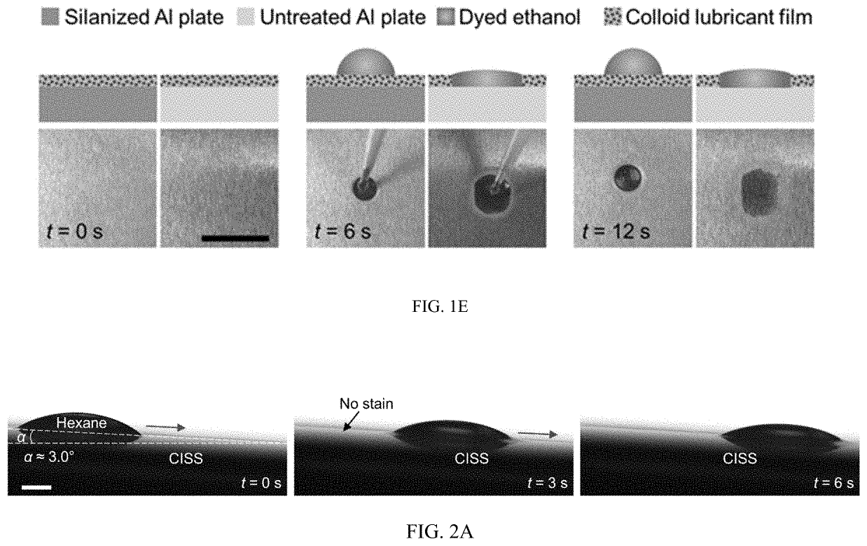

In embodiments colloid-infused smooth surfaces (CISSs), as illustrated in FIG. 1A, are capable of repelling common fluids and solids. The CISS is formed which fulfills the based three criteria, that where: the lubricating oil and wide variety of repelled liquids are immiscible; the colloidal particles have a preferential affinity for the lubricant oil over the repelled liquid; and the smooth solid are preferentially wetted by the colloid rather than the repelled liquid.

A colloid lubricating film on a smooth solid is essentially attributed to the introduction of nano/microparticles that is able to produce a mobile structural roughness to stabilize the lubricant oil. For analysis of the interfacial interaction between a colloid and a test liquid, the effect of the nano/microparticles, the particles are treated as forming a structured surface with a roughness factor rₚ. The particles must have a preferential affinity for the lubricant liquid rather than the test liquid, such that the test liquid freely floats on the lubricant oil stabilized on the particle-induced roughed surface. The total interfacial energy of three wetting configurations on the particle surfaces can be considered. The first case is that the particle surface is completely wetted by a test liquid (Eₐ), which can be further expressed as

Eₐ=rₚγₚₗ+γ₁ (1)

Where γₚₗ is the interfacial tension between the particle and the test liquid, and γₗ is the surface tension of the test liquid. The second configuration is that the particle surface is completely wetted by a lubricant oil (E_{b}), namely,

Eᵥ=rₚγₚₒ+γₒ (2)

where γₚₒ is the interfacial tension between the particle and the lubricant oil, and γₒ is the surface tension of the lubricant oil. The third wetting configuration is where the particle surface is completely wetted by a lubricant oil with a test liquid floating on top of it (E_{c}), derived as,

E_{c}=rₚγₚₒ+γₒₗ+γₗ (1)

where γₒₗ is the interfacial tension between the lubricant oil and the test liquid.

Substituting the Young equation γₚ=γₚₗ+γ₁ cos θₚₗ into equation (1) yields the following equation of Eₐ,

Eₐ=rₚ(γₚ−γₗ cos θₚₗ)+γₗ (4)

where γₚ is the surface tension of the particle, and θₚₗ is the intrinsic contact angle of the test liquid on a flat surface made of the particle material. Similarly, by substituting the Young equation γₚ=γₚₒ+γₒ cos θₚₒ into equations S2 and S3, yields

Eᵥ=rₚ(γₚ−γₒ cos θₚₒ)+γₒ (5)

E_{c}=rₚ(γₚ−γₒ cos θₚₒ)+γₒₗ+γₗ (6)

where θₚₒ is the intrinsic contact angle of the lubricant oil on a flat surface of the particle material.

To create a colloid film, in which the particle are not replaced by the test liquid, Eₐ should be always larger than E_{b} and E_{c}. Thus, ΔE₁=Eₐ−E_{b}>0 and ΔE₂=Eₐ−E_{c}>0. After substituting equations (4), (5) and (6), leads to

ΔE₁=Eₐ−E_{b}=rₚ(γₒ cos θₚₒ−γₗ cos θₚₗ)+γₗ−γₒ>0 (7)

ΔE₂=Eₐ−E_{c}=rₚ(γₒ cos θₚₒ−γₗ cos θₚₗ)−γₒₗ>0 (8)

Therefore, satisfying the interfacial energy conditions (7) and (8) meets the second criterion to form a stable colloid film to repel the external immiscible liquids. The colloidal particles' affinity ensures the stability of the colloid to the repelled liquid, as shown in FIG. 1B, and prevent the particles, as illustrated in FIG. 1C, from separating from the colloid into the repelled liquid. The colloidal particles are nano and/or microparticles act as a mobile structural roughness, as shown in FIG. 1D that stabilizes the lubricant oil on smooth solid substrates.

To ensure that the colloid film must stably adhere to the smooth solid, the interaction between the colloid and the smooth solid is considered. The smooth solid must be preferentially wetted by the colloid rather than by the tested liquid. Thus, the interfacial energies of smooth solids completely wetted by a test liquid (E_{d}) or a lubricant oil (Eₑ), expressed as,

E_{d}=γₛₗ+γₗ (9)

Eₑ=γ_{sc}+γ_{c} (10)

where γ_{c} is the surface tension of the colloid, is the interfacial tension between the smooth solid and the test liquid, and γ_{sc} is the interfacial tension between the smooth solid and the colloid. By substituting the Young equations γₛ=γₛₗ+γ₁ cos θₛₗ and γₛ=γ_{sc}+γ_{c} cos θ_{sc}, it can be deduced that

E_{d}=γₛ−γₗ cos θₛₗ+γₗ (10)

Eₑ=γₛ−γ_{c} cos θ_{sc}+γ_{c} (11)

where γₛ is the surface tension of the smooth solid, and θ_{sc} and θₛₗ are the intrinsic contact angles of the colloid and the test liquid on the smooth solid. To ensure that the smooth solid is preferentially wetted by the colloid rather than the test liquid, E_{d} should be larger than Eₑ, that is,

ΔE₃=E_{d}−Eₑ=γ_{c} cos θ_{sc}−γₗ cos θₛₗ+γₗ−γ_{c}>0 (12)

Taken together, ΔE₁>0, ΔE₂>0, and ΔE₃>0, must be simultaneously satisfied to create a stable CISS. If one of these conditions is not satisfied, the test liquid will not be repelled by the colloid. The colloid film should have a preferred affinity to adhere to smooth solids stably to form a mobile particle roughness and not be displaced by the repelled liquid at the surface, as illustrated in FIG. 1E. These theoretical criteria are consistent with results of the state of CISS under a number of different combinations of smooth solids, particles, colloids and test liquids, where the experimental results agree favorably with the theoretical criteria as shown in Table 1, below.

In an embodiment, the CISS can repel all states of matter: liquids, solids, and gas bubbles. In an exemplary embodiment, a stable colloid suspension is formed by inclusion of low-surface-energy polytetrafluoroethylene (PTFE) microparticles, as shown in FIGS. 1C and 1D, which is uniformly dispersed in a low-surface-tension perfluorinated oils, such as perfluorotripentylamine (FC-70, γₒ≈17.81 mN/m) and Krytox™ oils, where select properties are provided in Table 1, below. The ratio of the weight of the PTFE microparticles over the weight of the colloid is defined as mass fraction (ϕ) to quantify the particle component in the colloid. The synthesized colloid is immiscible with both aqueous and hydrocarbon fluids and is able to form a stable slippery interface on silylated smooth solids, such as silylated aluminum as indicated in FIG. 1E, thereby creating stable CISS surfaces that fully meet all criteria: ΔE₁>0, ΔE₂>0, and ΔE₃>0.

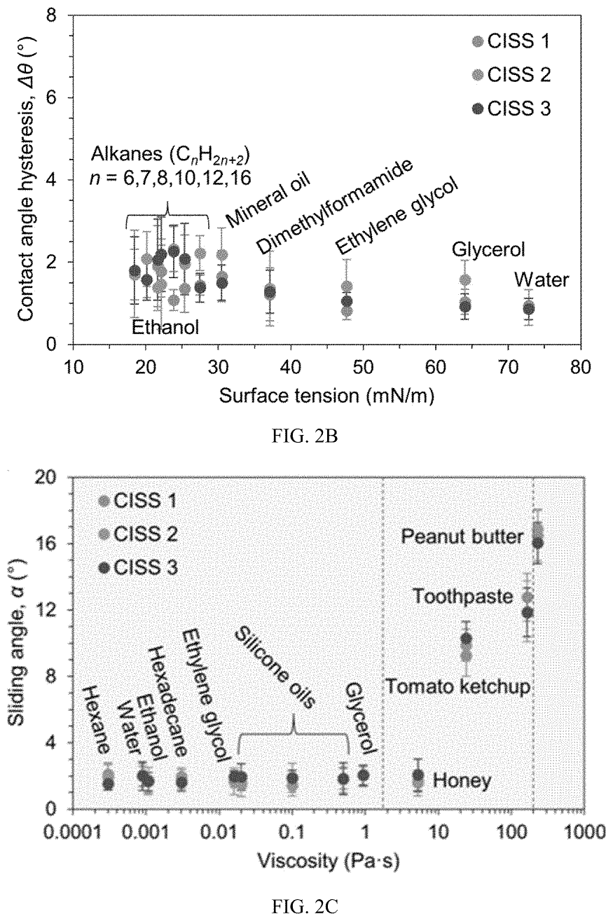

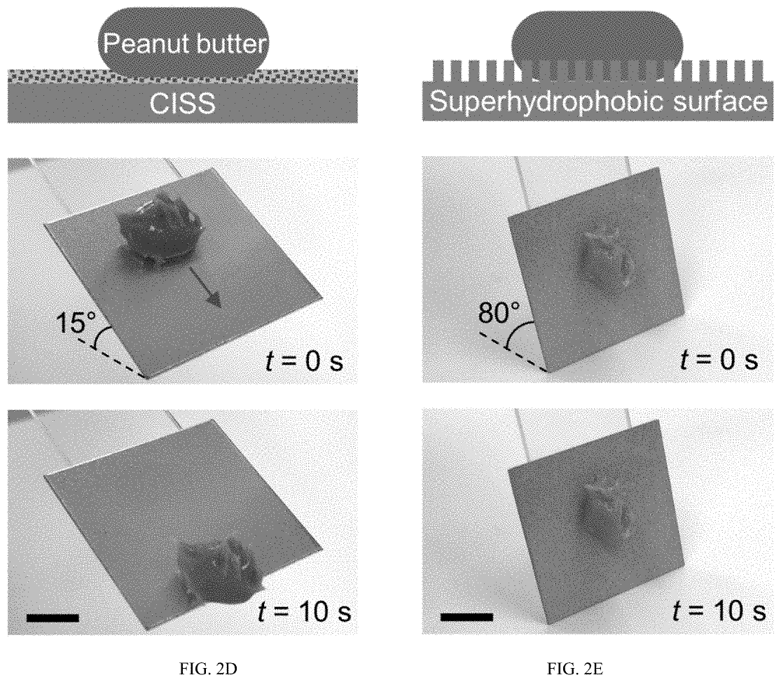

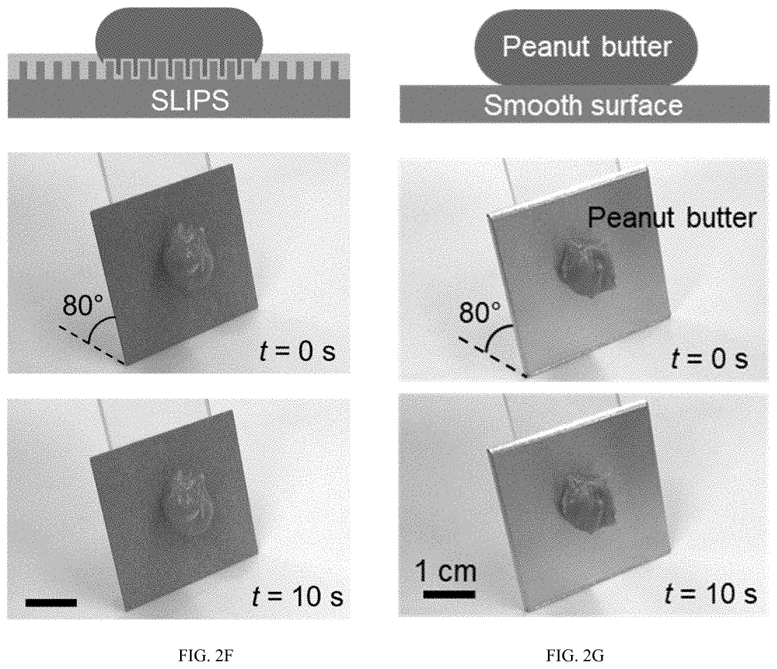

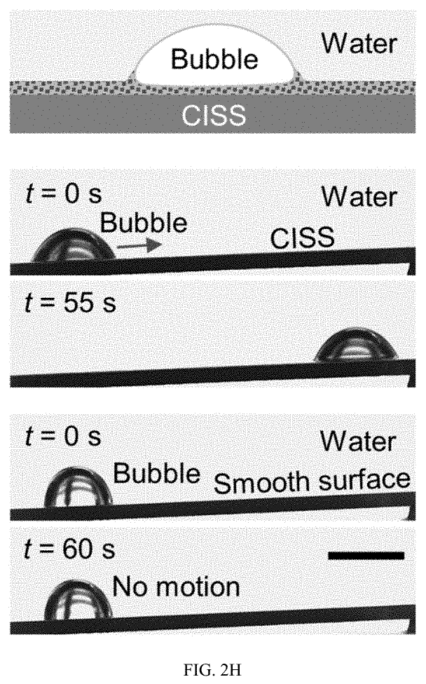

The designed CISS exhibits exceptional liquid repellency as evidenced by extremely low contact angle hysteresis Δθ<3.0°, as shown pictorially for the repelled liquid hexane in FIG. 2A and plotted for various liquids of different surface tensions in FIG. 2B, that allows the surface to possess a low sliding angles α<3.0°, as plotted in FIG. 2C for a variety of Newtonian fluids with surface tensions ranging from ˜18.4 mN/m (hexane, FIG. 2A) to ˜72.8 mN/m (water) and with a dynamic viscosities ranging from ˜0.0003 Pa·s (hexane) to ˜0.934 Pa·s (glycerol). Contact angle hysteresis Δθ is the difference between the advancing and receding contact angles of a droplet, while sliding angle α is the angle of surface inclination at which a droplet begins to move or slide. The very low values of Δθ and α shown in FIGS. 2B and 2C are analogous to that shown using SLIPS, suggests the CISS is a promising repellent and slippery platform without unfavorable pinning defects common to SLIPS. In addition to Newtonian fluids, the CISS is also able to effectively repel high-viscosity non-Newtonian fluids, such as honey, tomato ketchup, and toothpaste, as indicated in FIG. 2C. Distinct from Newtonian fluids, whose α on the CISS is virtually independent on the viscosity, the sliding angles of non-Newtonian fluids on the CISS generally increases with the increase of the viscosity. Tables 2, 3, 4, 5, and 6 below, give surface tensions, interfacial tensions with FC-70, and viscosities of various liquids that were tested with the CISS, according to embodiments.

TABLE 1
Comparison of the experimental results and theoretical design criteria to create stable CISS.

| | Test | | | | | | | | | | | | | | Stable CISS | |
|---|---|---|---|---|---|---|---|---|---|---|---|---|---|---|---|---|
| Solid | liquid | Colloid | rₚ | γₒ | γₗ | γₒₗ | γ_{c} | θₚₒ | θₚₗ | θ_{sc} | θₛₗ | ΔE₁ | ΔE₂ | ΔE₃ | The | Exp |
| S. Al | Hexadecane | PTFE | 3.69 | 17.81 | 27.47 | 9.86 | 17.84 | 5.0 | 70.9 | 10.0 | 59.4 | 42.0 | 22.4 | 13.2 | Y/Y/Y | Y |
| S. Al | Dodecane | ϕ = 0.01 | 3.69 | 17.81 | 25.35 | 7.75 | 17.84 | 5.0 | 62.6 | 10.0 | 52.5 | 30.0 | 14.7 | 9.6 | Y/Y/Y | Y |
| S. Al | Decane | | 3.69 | 17.81 | 23.83 | 6.55 | 17.84 | 5.0 | 50.0 | 10.0 | 47.0 | 15.0 | 2.4 | 7.3 | Y/Y/Y | Y |
| S. Al | Ethanol | | 3.69 | 17.81 | 22.1 | 10.01 | 17.84 | 5.0 | 60.5 | 10.0 | 37.1 | 29.6 | 15.3 | 4.2 | Y/Y/Y | Y |
| S. Al | Octane | | 3.69 | 17.81 | 21.62 | 4.84 | 17.84 | 5.0 | 44.7 | 10.0 | 33.9 | 12.6 | 3.9 | 3.4 | Y/Y/Y | Y |
| S. Al | Heptane | | 3.69 | 17.81 | 20.14 | 3.66 | 17.84 | 5.0 | 42.5 | 10.0 | 30.4 | 13.0 | 7.0 | 2.5 | Y/Y/Y | Y |
| S. Al | Hexane | | 3.69 | 17.81 | 18.43 | 2.17 | 17.84 | 5.0 | 31.5 | 10.0 | 25.1 | 8.1 | 5.3 | 1.5 | Y/Y/Y | Y |
| S. Al | Hexadecane | PTFE | 8.26 | 17.81 | 27.47 | 9.86 | 17.96 | 5.0 | 70.9 | 10.0 | 59.4 | 82.0 | 62.4 | 13.2 | Y/Y/Y | Y |
| S. Al | Dodecane | ϕ = 0.02 | 8.26 | 17.81 | 25.35 | 7.75 | 17.96 | 5.0 | 62.6 | 10.0 | 52.5 | 57.7 | 42.4 | 9.6 | Y/Y/Y | Y |
| S. Al | Decane | | 8.26 | 17.81 | 23.83 | 6.55 | 17.96 | 5.0 | 50.0 | 10.0 | 47.0 | 26.0 | 13.5 | 7.3 | Y/Y/Y | Y |
| S. Al | Ethanol | | 8.26 | 17.81 | 22.1 | 10.01 | 17.96 | 5.0 | 60.5 | 10.0 | 37.1 | 61.0 | 46.7 | 4.2 | Y/Y/Y | Y |
| S. Al | Octane | | 8.26 | 17.81 | 21.62 | 4.84 | 17.96 | 5.0 | 44.7 | 10.0 | 33.9 | 23.4 | 14.8 | 3.4 | Y/Y/Y | Y |
| S. Al | Heptane | | 8.26 | 17.81 | 20.14 | 3.66 | 17.96 | 5.0 | 42.5 | 10.0 | 30.4 | 26.2 | 20.2 | 2.5 | Y/Y/Y | Y |
| S. Al | Hexane | | 8.26 | 17.81 | 18.43 | 2.17 | 17.96 | 5.0 | 31.5 | 10.0 | 25.1 | 17.4 | 14.6 | 1.5 | Y/Y/Y | Y |
| U. Al | Hexadecane | PTFE | 3.69 | 17.81 | 27.47 | 9.86 | 17.84 | 5.0 | 70.9 | 20.9 | 14.7 | 42.0 | 22.4 | −0.3 | Y/Y/N | N |
| U. Al | Dodecane | ϕ = 0.01 | 3.69 | 17.81 | 25.35 | 7.75 | 17.84 | 5.0 | 62.6 | 20.9 | 7.2 | 30.0 | 14.7 | −1.0 | Y/Y/N | N |
| U. Al | Decane | | 3.69 | 17.81 | 23.83 | 6.55 | 17.84 | 5.0 | 50.0 | 20.9 | 5.0 | 15.0 | 2.4 | −1.1 | Y/Y/N | N |
| U. Al | Ethanol | | 3.69 | 17.81 | 22.1 | 10.01 | 17.84 | 5.0 | 60.5 | 20.9 | 5.0 | 29.6 | 15.3 | −1.1 | Y/Y/N | N |
| U. Al | Octane | | 3.69 | 17.81 | 21.62 | 4.84 | 17.84 | 5.0 | 44.7 | 20.9 | 5.0 | 12.6 | 3.9 | −1.1 | Y/Y/N | N |
| U. Al | Heptane | | 3.69 | 17.81 | 20.14 | 3.66 | 17.84 | 5.0 | 42.5 | 20.9 | 0.0 | 13.0 | 7.0 | −1.2 | Y/Y/N | N |
| U. Al | Hexane | | 3.69 | 17.81 | 18.43 | 2.17 | 17.84 | 5.0 | 31.5 | 20.9 | 0.0 | 8.1 | 5.3 | −1.2 | Y/Y/N | N |
| U. Al | Hexadecane | PTFE | 8.26 | 17.81 | 27.47 | 9.86 | 17.96 | 5.0 | 70.9 | 21.7 | 14.7 | 82.0 | 62.4 | −0.4 | Y/Y/N | N |
| U. Al | Dodecane | ϕ = 0.02 | 8.26 | 17.81 | 25.35 | 7.75 | 17.96 | 5.0 | 62.6 | 21.7 | 7.2 | 57.7 | 42.4 | −1.1 | Y/Y/N | N |
| U. Al | Decane | | 8.26 | 17.81 | 23.83 | 6.55 | 17.96 | 5.0 | 50.0 | 21.7 | 5.0 | 26.0 | 13.5 | −1.2 | Y/Y/N | N |
| U. Al | Ethanol | | 8.26 | 17.81 | 22.1 | 10.01 | 17.96 | 5.0 | 60.5 | 21.7 | 5.0 | 61.0 | 46.7 | −1.2 | Y/Y/N | N |
| U. Al | Octane | | 8.26 | 17.81 | 21.62 | 4.84 | 17.96 | 5.0 | 44.7 | 21.7 | 5.0 | 23.4 | 14.8 | −1.2 | Y/Y/N | N |
| U. Al | Heptane | | 8.26 | 17.81 | 20.14 | 3.66 | 17.96 | 5.0 | 42.5 | 21.7 | 0.0 | 26.2 | 20.2 | −1.3 | Y/Y/N | N |
| U. Al | Hexane | | 8.26 | 17.81 | 18.43 | 2.17 | 17.96 | 5.0 | 31.5 | 21.7 | 0.0 | 17.4 | 14.6 | −1.3 | Y/Y/N | N |
| S. Al | Hexadecane | Silica | 6.19 | 17.81 | 27.47 | 9.86 | 18.70 | 33.7 | 41.5 | 8.4 | 59.4 | −26.0 | −45.5 | 13.3 | N/N/Y | N |
| S. Al | Dodecane | ϕ = 0.01 | 6.19 | 17.81 | 25.35 | 7.75 | 18.70 | 33.7 | 36.2 | 8.4 | 52.5 | −27.4 | −42.7 | 9.7 | N/N/Y | N |
| S. Al | Decane | | 6.19 | 17.81 | 23.83 | 6.55 | 18.70 | 33.7 | 27.5 | 8.4 | 47.0 | −33.1 | −45.7 | 7.4 | N/N/Y | N |
| S. Al | Ethanol | | 6.19 | 17.81 | 22.1 | 10.01 | 18.70 | 33.7 | 36.2 | 8.4 | 37.1 | −14.4 | −28.7 | 4.3 | N/N/Y | N |
| S. Al | Octane | | 6.19 | 17.81 | 21.62 | 4.84 | 18.70 | 33.7 | 17.6 | 8.4 | 33.9 | −32.0 | −40.7 | 3.5 | N/N/Y | N |
| S. Al | Heptane | | 6.19 | 17.81 | 20.14 | 3.66 | 18.70 | 33.7 | 7.3 | 8.4 | 30.4 | −29.6 | −35.6 | 2.6 | N/N/Y | N |
| S. Al | Hexane | | 6.19 | 17.81 | 18.43 | 2.17 | 18.70 | 33.7 | 5.2 | 8.4 | 25.1 | −21.3 | −24.1 | 1.5 | N/N/Y | N |
| U. Al | Hexadecane | Silica | 6.19 | 17.81 | 27.47 | 9.86 | 18.70 | 33.7 | 41.5 | 28.2 | 14.7 | −26.0 | −45.5 | −1.3 | N/N/N | N |
| U. Al | Dodecane | ϕ = 0.01 | 6.19 | 17.81 | 25.35 | 7.75 | 18.70 | 33.7 | 36.2 | 28.2 | 7.2 | −27.4 | −42.7 | −2.0 | N/N/N | N |
| U. Al | Decane | | 6.19 | 17.81 | 23.83 | 6.55 | 18.70 | 33.7 | 27.5 | 28.2 | 5.0 | −33.1 | −45.7 | −2.1 | N/N/N | N |
| U. Al | Ethanol | | 6.19 | 17.81 | 22.1 | 10.01 | 18.70 | 33.7 | 36.2 | 28.2 | 5.0 | −14.4 | −28.7 | −2.1 | N/N/N | N |
| U. Al | Octane | | 6.19 | 17.81 | 21.62 | 4.84 | 18.70 | 33.7 | 17.6 | 28.2 | 5.0 | −32.0 | −40.7 | −2.1 | N/N/N | N |
| U. Al | Heptane | | 6.19 | 17.81 | 20.14 | 3.66 | 18.70 | 33.7 | 7.3 | 28.2 | 0.0 | −29.6 | −35.6 | −2.2 | N/N/N | N |
| U. Al | Hexane | | 6.19 | 17.81 | 18.43 | 2.17 | 18.70 | 33.7 | 5.2 | 28.2 | 0.0 | −21.3 | −24.1 | −2.2 | N/N/N | N |

“S. Al” and “U. Al” indicate the silanized and untreated smooth aluminum substrates. “Y” and “N” in theoretical column (“The.”) represent whether the corresponding criterion is satisfied or not. For example, “Y/Y/Y” indicates three criteria are all satisfied, that is, ΔE₁>0, ΔE₂>0, and ΔE₃>0, while “Y/Y/N” indicates ΔE₁>0, ΔE₂>0, and ΔE₃<0. “Y” in experimental column (“Exp.”) indicates the designed CISS is stable, while “N” indicates the CISS is not stable, where the colloid is replaced by the test liquid. Φ is the mass fraction, rₚ is the roughness factor, γₒ is the surface tension of the lubricant oil (see Table 2, below), γₗ is the surface tension of the used test liquids (see Table 3, below), γₒₗ is the interfacial tension between the lubricant oil and the test liquids (see Table 4, below), and θₚₒ, θₚₗ, θ_{sc} and θₛₗ are the intrinsic contact angles of the lubricant oil on a flat particle surface, the test liquid on a flat particle surface, the colloid on a smooth solid, and the test liquid on a smooth solid (see Table 5, below).

TABLE 2
Physical and chemical properties of the lubricant oils.

| | Surface | Dynamic | |
|---|---|---|---|
| | tension | viscosity | Chemical |
| Name | (mN/m) | (mPa · s) | Source &Grade |
| Perfluorotripentylamine | 17.81 ± 0.07 ^{a} | 22.27 ± 0.47 ^{b} | Aladdin |
| (FC-70) | | | (used in density |
| | | | gradient studies) |
| Krytox GPL 101 | 16-20 ^{b} | 17.4 ^{b} | Dupont ™ Krytox ® |
| Krytox GPL 103 | 16-20 ^{b} | 82 ^{b} | Dupont ™ Krytox ® |

Note:
Properties were collected at 20° C. unless otherwise specified as superscript. Reference sources: ^{(a)} surface tension and viscosity were obtained from five independent measurements at ambient conditions; ^{(b)} manufacturer specifications.

TABLE 3
Surface tension of the tested liquids repelled by the CISS.

| | Surface tension | |
|---|---|---|
| Name | (mN/m) | Chemical Source &Grade |
| Hexane | 18.43 ^{b} | J&K Scientific (97.5%) |
| Heptane | 20.14 ^{b} | Aladdin (>99.5%) |
| Octane | 21.62 ^{b} | Aladdin (>99%) |
| Ethanol | 22.10 ^{b} | VWR International (99.95%) |
| Decane | 23.83 ^{b} | Aladdin (>99%) |
| Dodecane | 25.35 ^{b} | Aladdin (>99%) |
| Hexadecane | 27.47 ^{b} | Aladdin (98%) |
| Mineral oil | 30.45 ± 0.03 ^{a} | Sigma-Aldrich (Light oil) |
| N, N-dimethyl | 37.10 b | J&K Scientific (≥99.9%) |
| formamide (DMF) | | |
| Ethylene glycol | 47.70 ^{b} | Aladdin (>99%) |
| Glycerol | 64.00 ^{b} | Sigma-Aldrich (≥99.5%) |
| Deionized water | 72.80 ^{b} | HKU Nanofluids Lab |

Note:
Properties were: collected at 20° C. unless otherwise specified as superscript. Reference sources: ^{(a)} surface tension was calculated from five independent measurements by the Wilhelmy plate method at ambient conditions (22° C. to 25° C.); ^{(b)} DataPhysics (https://www.dataphysics-instruments.com/Downloads/Surface-Tensions-Energies.pdf).

TABLE 4
Measured interfacial tensions between FC-70 oil and various liquids.

| | | (1) Interfacial tension | |
|---|---|---|---|
| Liquid/liquid | | (mN/m) | |
| (2) | FC-70/Hexadecane | (3) | 9.86 ± 0.39 |
| (4) | FC-70/Dodecane | (5) | 7.75 ± 0.43 |
| (6) | FC-70/Decane | (7) | 6.55 ± 0.26 |
| (8) | FC-70/Ethanol | (9) | 10.01 ± 0.19 |
| (10) | FC-70/Octane | (11) | 4.84 ± 0.09 |
| (12) | FC-70/Heptane | (13) | 3.66 ± 0.13 |
| (14) | FC-70/Hexane | (15) | 2.17 ± 0.14 |

Note:
Interfacial tension measurements were performed by the pendant droplet method at ambient conditions (22° C. to 25° C.). These interfacial tensions were calculated from fifteen independent measurements.

TABLE 5
Measured roughness factor for the colloid on aluminum substrate.

| Colloid | Roughness factor |
|---|---|
| PTFE + FC-70 (ϕ = 0.01) | 3.69 ± 0.39 |
| PTFE + FC-70 ( ϕ = 0.02) | 8.26 ± 0.55 |
| Silica + FC-70 (ϕ = 0.01) | 6.19 ± 0.53 |

Note:
Roughness factors were measured at ambient conditions (22° C. to 25° C.), and calculated from five independent measurements.

TABLE 6
Viscosity of the tested liquids repelled by the CISS.

| Name | Dynamic viscosity (Pa · s) | Chemical Source &Grade |
|---|---|---|
| Hexane | 0.0003 ^{a} | J&K Scientific (97.5%) |
| Deionized water | 0.00089 ^{a} | HKU Nanofluids Lab |
| Ethanol | 0.001074 ^{a} | VWR International (99.95%) |
| Hexadecane | 0.00303 ^{a} | Aladdin (98%) |
| Ethylene glycol | 0.01606 ^{a} | Aladdin (>99%) |
| Silicone oil | 0.02 ^{b} | Aladdin PMX-200 |
| Silicone oil | 0.1 ^{b} | Aladdin PMX-200 |
| Silicone oil | 0.5 ^{b} | Aladdin PMX-200 |
| Glycerol | 0.934 ^{a} | Sigma-Aldrich (≥99.5%) |
| Honey | 5.26 ± 0.07 ^{c} | BESTbuy Centifloral Honey |
| Tomato ketchup | 23.96 ± 0.18 ^{c} | Delmonte Ketchup |
| Toothpaste | 163.65 ± 0.71 ^{c} | Colgate Anticavity Toothpaste |
| Peanut butter | 228.72 ± 10.56 ^{c} | Skippy Creamy Peanut Butter |

Note:
Properties are collected at 25° C. unless otherwise specified as superscript. Reference sources: ^{(a)} CRC; ^{(b)} manufacturer specifications, ^{(c)} dynamic viscosity was calculated from five independent measurements tested by Brookfield rheometer at a speed of 0.1 rpm.

TABLE 7
Measured surface tensions for the colloid lubricants.

| Colloid | Surface tension (mN/m) |
|---|---|
| PTFE + FC-70 (ϕ = 0.01) | 17.84 ± 0.04 |
| PTFE + FC-70 (ϕ = 0.02) | 17.96 ± 0.08 |
| Silica + FC-70 (ϕ = 0.01) | 18.70 ± 0.04 |

calculated from five independent measurements by the Wilhelmy plate method at ambient conditions (22° C. to 25° C.).

In addition to repelled fluids, the CISS resists adhesion of viscoelastic solids, as shown in FIG. 2D. Reducing the adhesion of viscoelastic solids to solid surfaces requires lowering the adhesion work, expressed as Wₛ≈2rₛ(γₛ·γᵥₛ)^{1/2}, here rₛ is the roughness factor of the solid substrate, γₛ is the interfacial energy of the solid, and γᵥₛ is the interfacial energy of the viscoelastic solid, respectively. An ultralow adhesion work can be achieved on our CISS owing to the absence of structural roughness (rₛ≈1.0) and the stable lubricating effect of the colloid. Thus, our CISS exhibits an extraordinary repellency to the viscoelastic solids, as evidenced by the contamination-free sliding of a small piece of peanut butter on an inclined CISS at α≈15° in FIG. 2D. On the contrary, viscoelastic peanut butter can unfavorably stick to superhydrophobic surfaces, as shown in FIG. 2E, SLIPS surface, as shown in FIG. 2F, as well as conventional smooth surfaces, as shown in FIG. 2G. In addition to viscoelastic peanut butter, the CISS can also impart the capability of repelling solid ice, which is similar to the anti-icing behavior on the SLIPS.

FIG. 2H shows gas repellency of the developed CISS under water. A gas bubble, as indicated in the schematic drawing and shown in time-lapse photography for a ˜30 μl gas bubble in a middle panel, easily slides upward with no stain to the surface on an inclined CISS (α≈2.5°) under water. Such a bubble motion suggests that the colloid film infused on a smooth substrate is stable under water. Without the colloid layer, the gas bubble sticks to the smooth substrate without any motion, as illustrated in the time-lapse photographs in FIG. 2H, bottom panel. The CISSs according to embodiments are capable of superior repellency against different phases of matter, including: Newtonian and non-Newtonian fluids; viscoelastic solids; solid ice; and underwater bubbles.

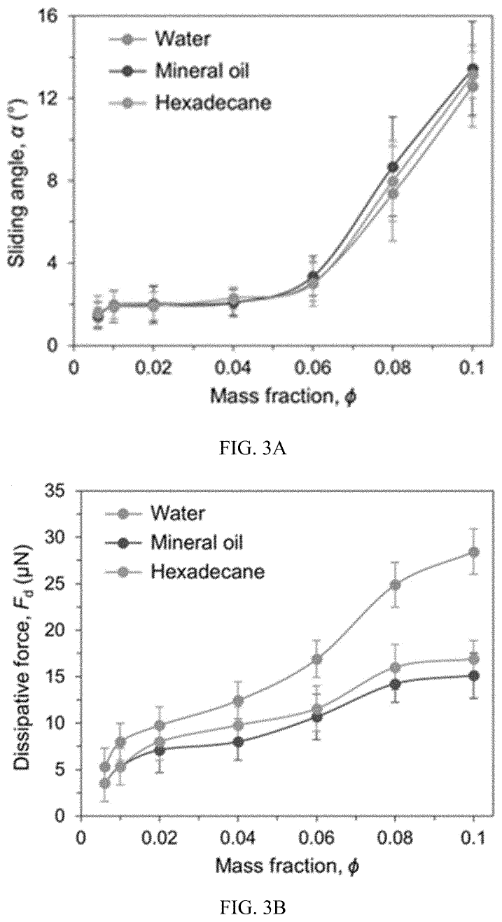

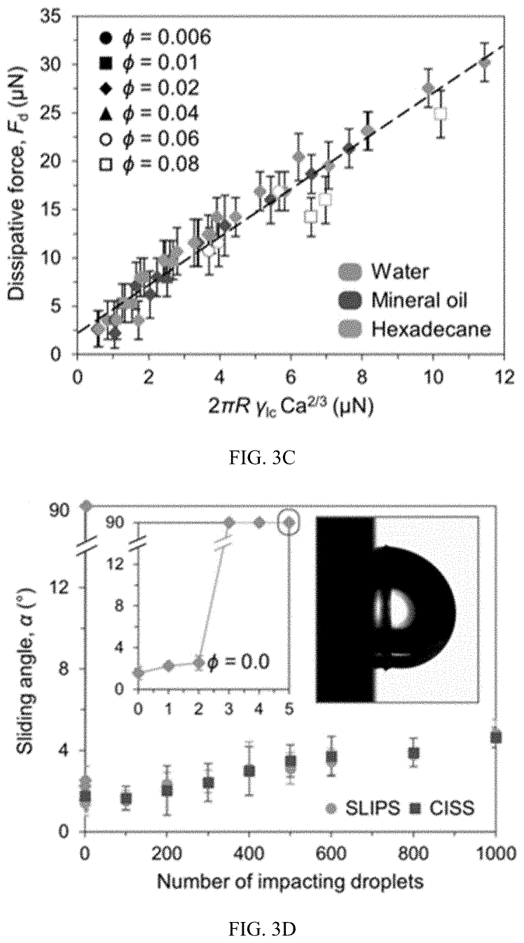

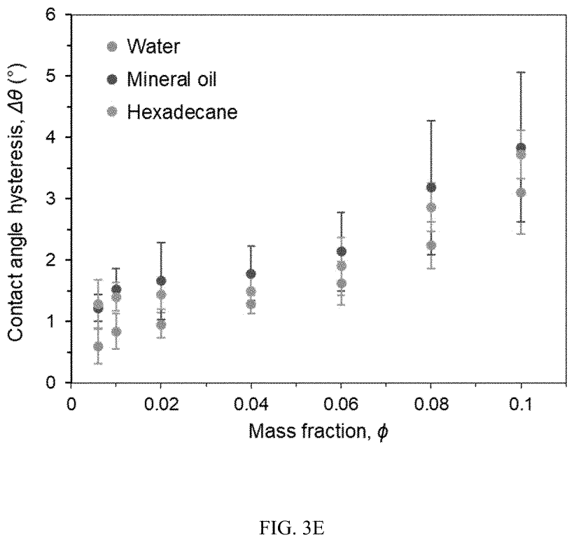

The particle fraction in the colloid mediates repellency dynamics. This is indicated by the slippery behaviors of three types of fluid droplets on CISSs having colloids with different mass fractions, ϕ, of particles. In FIG. 3A, when ϕ<˜0.06, the sliding angle of the droplets on the CISS shows a slowly increasing trend, within α<5°, while it increases rapidly with the increase of ϕ when ϕ>˜0.06. Similarly, contact angle hysteresis Δθ of these droplets on the CISSs also increases with increasing ϕ. The variation of the sliding angle and contact angle hysteresis can be intrinsically attributed to the viscous dissipative force F_{d} that resists the movement of the droplets on the CISS, since

F_{d}≈mg sin α≈2πRγₗ(cos θᵣ−cos θₐ) (4)

where m is the weight of the droplet, g is the gravitational acceleration, R is the droplet base radius, and θₐ and θᵣ are the advancing and receding contact angles, respectively. Quantification of the dissipative force, F_{d}, acting on a moving droplet can be measure at a constant speed using a cantilever force sensor. As displayed in FIG. 3B, as ϕ increases, all dissipative forces for water, mineral oil and hexadecane droplets increase accordingly, which results in the grow of α and Δθ on the CISS.

For a moving droplet on a CISS, the dissipative force F_{d} on the CISS can be quantified by integrating the viscous stress ηU/h over the area 2πRl, where η is the colloid viscosity, U is the constant speed of the droplet, h is the thickness of the colloid film, and l is the area size of capillary pressure flow at the rim around the droplet base. Since the formation of the colloid film follows the Landau-Levich-Derjaguin law, where l˜RCa^{1/3} and h˜RCa^{2/3}, the dissipative force F_{d} on the CISS can be estimated as

F_{d}≈2πRγ_{lc}Ca^{2/3} (5)

Where Ca=ηU/γ_{lc} is the capillary number, and γ_{lc} is the interfacial tension between the colloid and the test liquid. Such scaling of F_{d} is indicated in FIG. 3C for three types of fluid droplets with volumes of 1-10 μl moving at speeds of 0.1-5 mm/s on the CISS infused by colloidal particles at ϕ=0.006-0.08. Since η, γ_{c} and γ_{lc} are determined by ϕ, the particle fraction of the colloid mediates the dissipative force as evidenced in FIG. 3B, which regulates repellency of the CISS as shown by the sliding angle in FIG. 3A and contact angle hysteresis.

The long-term stability of the CISS can be mediated by the particle fraction of the colloid, as indicated by droplet impacting test on the CISS surfaces with different mass fraction, ϕ. When ϕ is smaller than 0.01, the colloid film on the CISS can be broken down by the impinging droplets. However, when ϕ≥0.01, the colloid film forms a stabilized CISS under continuous droplet impacting, which is the same as that observed with a SLIPS, as indicated in FIG. 3D. Without the stabilization effect of the microparticles, the lubricating oil film on a smooth surface is easily destroyed by the impacting droplets, as indicated in the FIG. 3D inset. By choosing an oil with a minimal evaporation rate or an enhanced viscosity, such as Krytox™ oils, a CISS displays long-term slippery coatings on smooth materials with extraordinary matter repellency. The mass fraction of particles is optimal as low mass fraction ϕ≤0.06, as indicated in FIG. 3E.

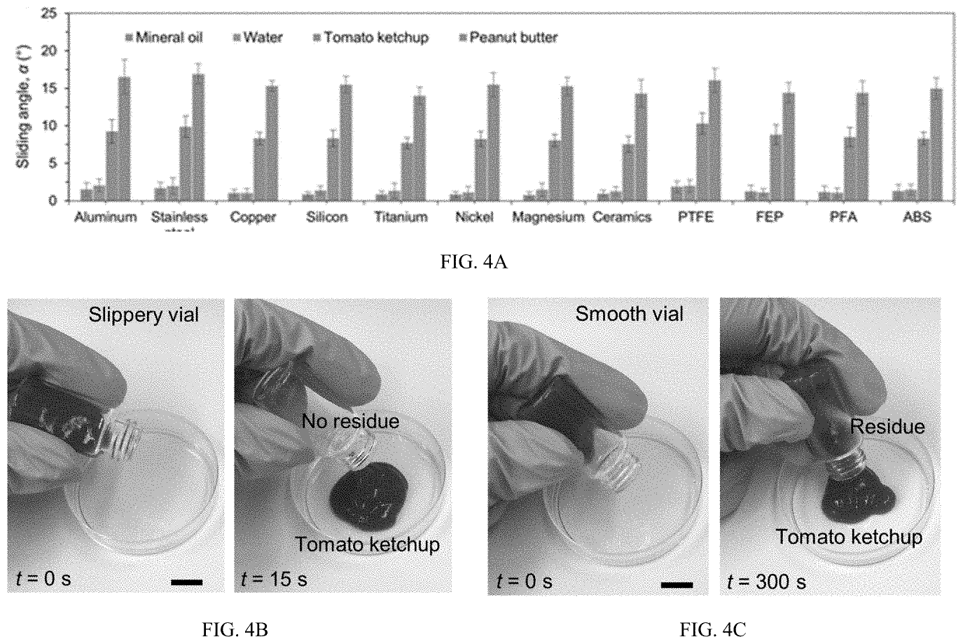

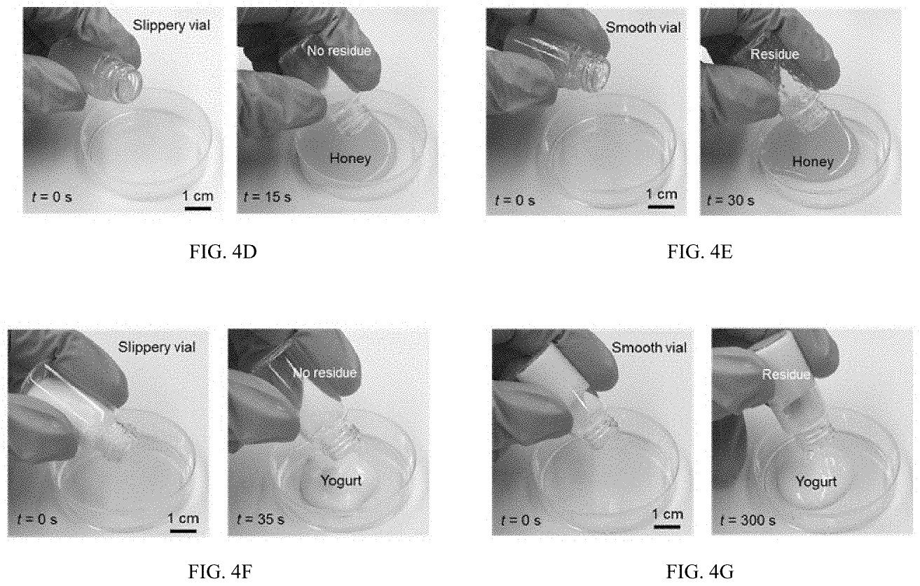

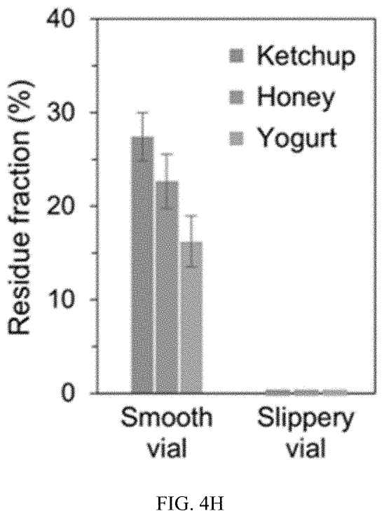

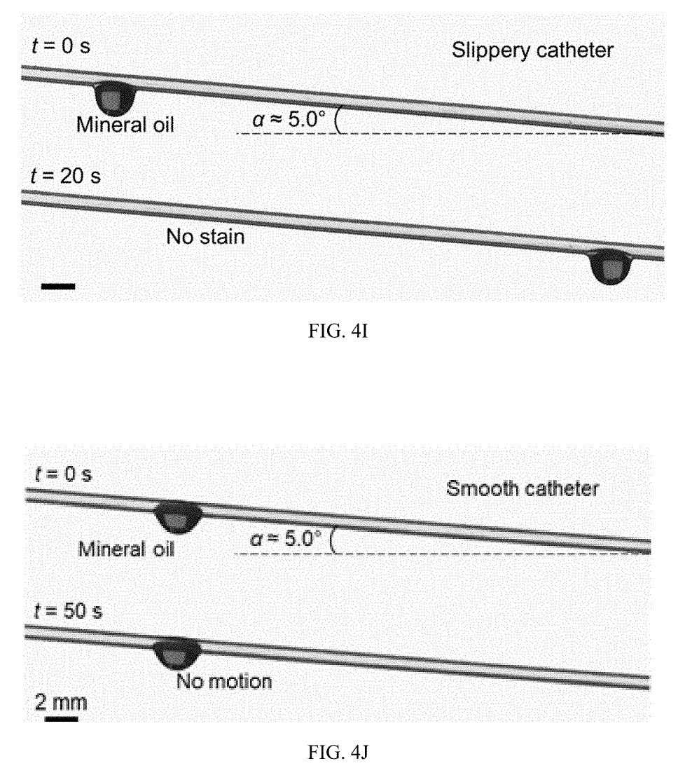

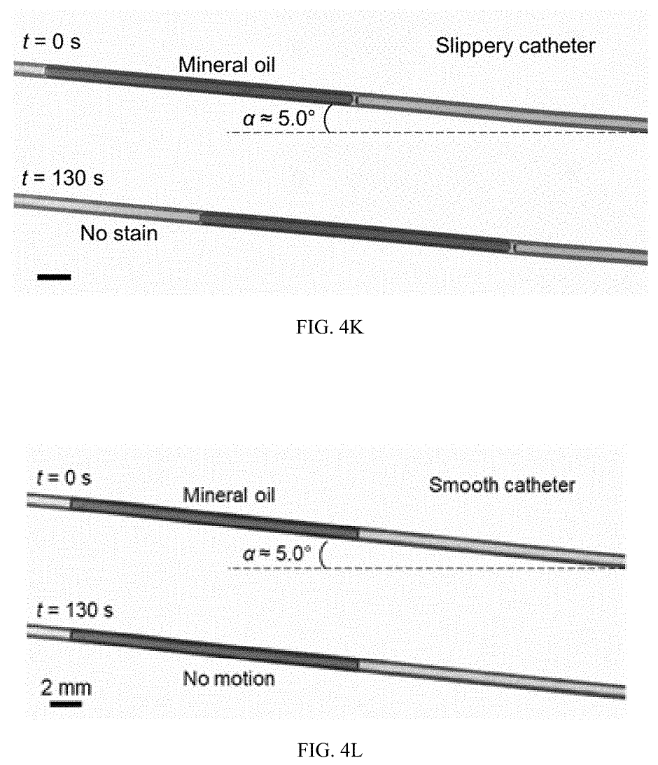

CISSs are successfully fabricated on various materials with roughness factors from 1.00 to 1.45 including metals (aluminum, stainless steel, copper, titanium, nickel, and magnesium alloy), silicon, ceramics, and plastics (PTFE, FEP, PFA and ABS). These CISS surfaces exhibit superior repellency against mineral oil, water, tomato ketchup and peanut butter, as shown in FIG. 4A. Distinct from the conventional SLIPS that is favorable for open surfaces, a CISS can be readily and stably manufactured inside closed vessels and catheters, which allows a number of applications. FIG. 4B presents that tomato ketchup can easily slip out of the slippery CISS glass vial without any residue in contrast to the large proportion of tomato ketchup that stably sticks to the inner surface of a smooth glass vial, as shown in FIG. 4C. In like manner, FIGS. 4D and 4E, and FIGS. 4F and 4G, show the ready slippage of honey and yogurt, respectively, relative to the sticking in smooth glass vials. By using slippery CISS vials, the residues of daily foods such as ketchup, honey, and yogurt, can be reduced to nearly zero, as indicated in FIG. 4H, effectively preventing food waste, and promoting a sustainable recycling of slippery vials. A CISS can be formed simultaneously on the outer and inner surfaces of a PTFE catheter to form a slippery CISS catheter. As shown in FIG. 4I and FIG. 4K, mineral oil can freely slide on and inside, respectively, of the inclined slippery CISS catheter without contaminations from the CISS, which is a significant improvement over traditional smooth catheter for contamination-free fluid movements on and in a catheter, as shown in FIG. 4J and FIG. 4L, respectively.

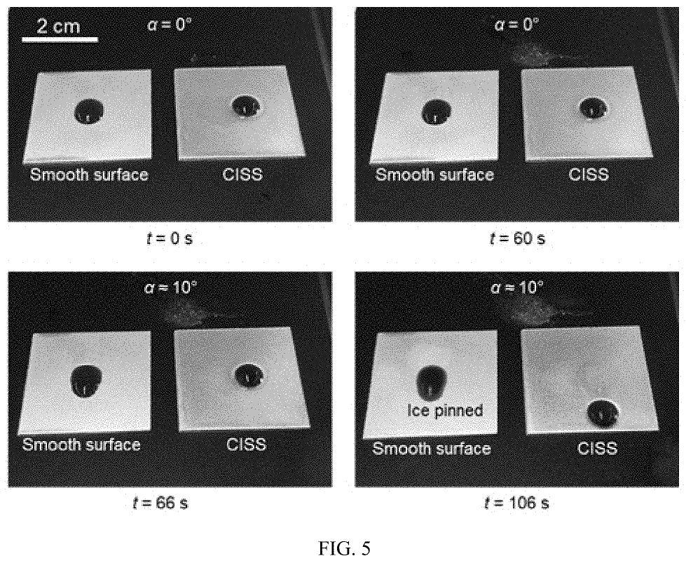

Although, as described herein with perfluorinated fluid, such as, but not limited to perfluorotripentylamine (FC-70) and Krytox™ oils, the non-volatile lubricating fluid can be another liquids, such as silicone oils, mineral oils, ferrofluid, ionic liquid, polyalphaolefin oils, and hydroxy-terminated polydimethylsiloxanes for CISS surfaces that can be paired to repelling of liquids and solids that are immiscible with the liquid and particles that have a high affinity to the non-volatile lubricating fluid over any material to be repelled. The nanoparticles and/or microparticles can be waxes, silica, titanium oxide, silver, and graphene, which have, or can be surface functionalized to have a preferred affinity for the lubricating fluid over the material that is to be repelled. The surface of the nanoparticles and/or microparticles can be treated with a silylating agent, a functional trialkoxylsilane, trichlorosilane, silazane, or other silylating reagent, to bond a functional group to the surface that provides a particle's surface with affinity to the lubricating fluid but not the liquid to be repelled. The CISS surface is repellant to all fluids that are not miscible with the lubricating fluid. For example, the silicone or hydrocarbon oil can repel aqueous solutions or ice. As shown in FIG. 5, a plate with a CISS promotes the flow of ice at an angle of 10°.

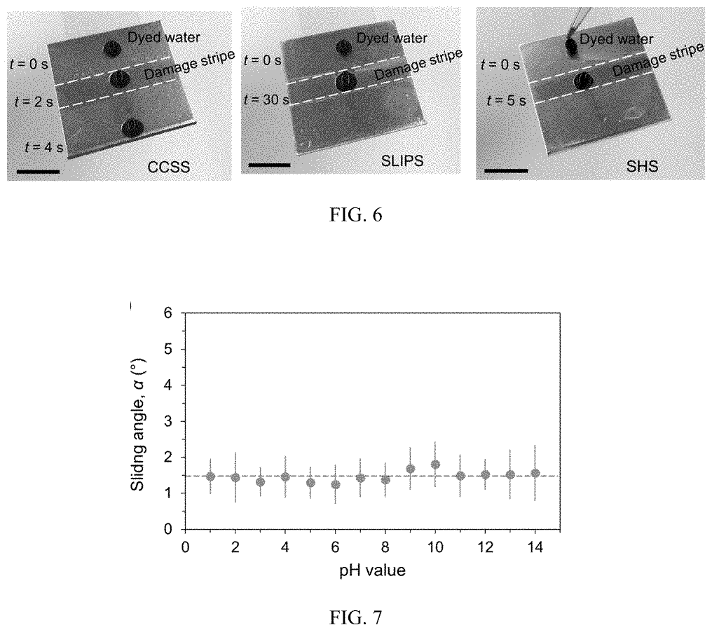

The CISS shows superior self-healing after various mechanical damage to the surface including wiping, touching, tape peeling, blade scratching, and sandpaper wearing, benefiting from an intelligent self-built roughness of the colloid. Unlike state of the art repellent surface that are predesigned with fixed surface structures, the particle-enabled roughness within the colloid are intrinsically movable. Therefore, the colloid film flows into the damage area on the smooth solid by capillary or gravity action to restore the damaged colloid film. As shown in FIG. 6, a dyed water droplet can quickly slide across a mechanical wiping stripe of about 5 mm width on an inclined CISS, left, after self-healing of the colloid film in the damaged region in contrast to a water droplet arrested by the wiping stripe on a SLIPS, middle, because the severe damage to the nanostructures that completely destroys any trapping and stabilization of the oil film, or to a SHS, right, that loses liquid repellency after mechanical wiping. This intelligent self-roughness by the colloid film is remarkably beneficial for the creation of anti-damage and self-healing slippery coatings.

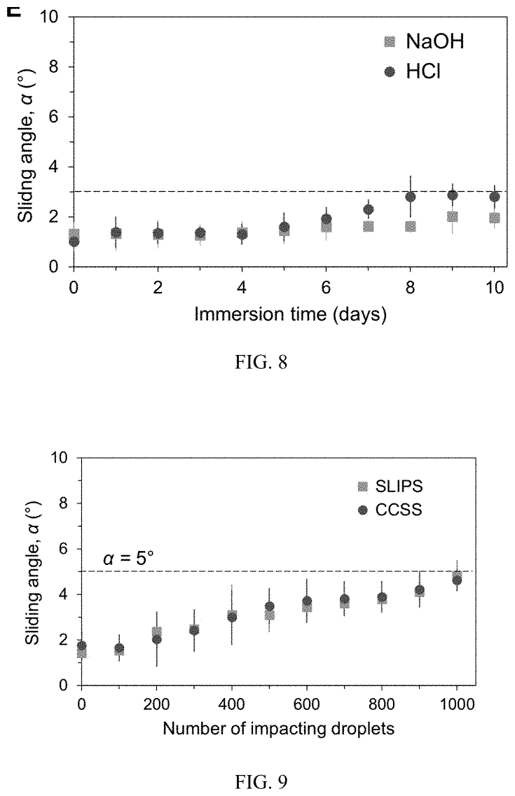

In addition to superior resistance to mechanical damage, the CISS is endowed with an excellent resistance to chemical damage. The chemical resistance is indicated by the stable repellency to droplets at different pH values, as shown in FIG. 7, where the sliding angle of water droplets is less than 2° regardless of the pH of the droplets. This chemical stability is demonstrated after long-term immersion in the hydrochloric acid (HCl) and sodium hydroxide (NaOH) solutions, as illustrated in FIG. 8. The sliding angle of water droplet on the CISS soaked in the NaOH solution remains unchanged for at least 10 days, while the CISS immersed in HCl solution, shows only a small increase in sliding angle, less than 3°, for water droplet over 10 days.

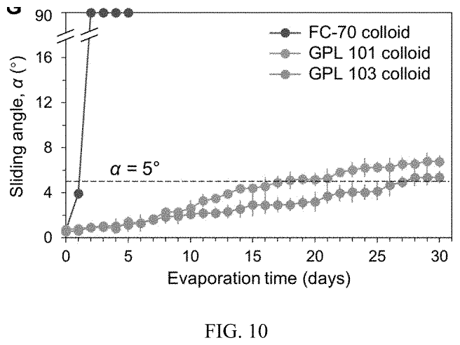

The stability of CISS remains with little change after continuous droplet impact on the inclined CISS which is similar to that of for SLIPS, FIG. 9, where the sliding angle of water droplets increases gradually through the impacting of one thousand droplets, consecutively, on an inclined CISS, remaining within 5°, indicating that the CISS retains a good slippery and repellency state, similar to that of a conventional SLIPS. A rational selection of the oil used to create the colloid is significant for the long-term stability of a CISS. Appropriate oils display a minimal evaporation rate with an enhanced viscosity, such as Dupont Krytox™ oils, that create slippery coatings with long-term stable. For example, by taking advantage of GPL 103 oil to make the colloid, the sliding angle of water droplets on the CISS remains approximately unchanged, within 5°, over a thirty-day consecutive evaporation test, as shown in FIG. 10.

Hence, in embodiments of invention, stable matter-repellent slippery surfaces are prepared on smooth solids by coating a colloid suspension consisting of a lubricant oil and functional microparticles. The slippery coatings do not require structured substrate surfaces or deposition of auxiliary layers to entrench a thin lubricant film, rather the colloid is a self-stabilized lubricating film without aid of structural roughness planarizes to a smooth surface with exceptional repellency against all states of matter, including bubbles, fluids, viscoelastic solids, and solid ice. Different from the monotonous repellency to single-phase foulant on the previous liquid-repellent surfaces, such comprehensive repellency to foulants with different phases allows our CISS to normally work under extreme conditions that simultaneous results in contamination from materials in multiple states of matter. Various smooth substrates that can be employed to form CISSs including metals, silicon, glass, ceramics, and plastics. In addition to open surfaces, CISSs can be formed on the surfaces of closed spaces, including bottles and catheters, since there is no need to generate structural roughness on closed surfaces in advance. These advantages enable a wide range of promising applications as exemplified by slippery vials for preventing food adhesion and slippery catheters for contamination-free fluid navigation.

It should be understood that the examples and embodiments described herein are for illustrative purposes only and that various modifications or changes in light thereof will be suggested to persons skilled in the art and are to be included within the spirit and purview of this application. In addition, any elements or limitations of any invention or embodiment thereof disclosed herein can be combined with any and/or all other elements or limitations (individually or in any combination) or any other invention or embodiment thereof disclosed herein, and all such combinations are contemplated with the scope of the invention without limitation thereto.

### Materials and Methods

Synthesis of Colloid Lubricants

PTFE microparticles were added into low-surface-tension perfluorinated oils, including FC-70 and Chemours™ Krytox™ oils, at specific mass fractions. The suspensions were subsequently exposed to ultrasound sonication for 1 hour and magnetic stirring for 2 hours to create a stable colloid suspension.

Preparation of CISS

To enhance the affinity between the colloid and smooth solid substrates, the solid surfaces, including aluminum, stainless steel, copper, silicon, titanium, nickel, magnesium alloy, ceramics, ABS, and glass vials, were silylated by immersing the substrate in a 1 mM ethanol solution of 1H,1H,2H,2H-perfluorodecyltrichlorosilane for about six hours, followed by heat treatment at 80° C. in air for one hour. The colloid was fully infused on these solid surfaces by capillary wetting or spraying. Excess lubrication film was drained from the smooth surface for 30 minutes via gravity. Unless otherwise specified, the colloid suspension consist of FC-70 oil and PTFE microparticles with a mass fraction of 0.02 was used throughout experiments.

Preparation of Superhydrophobic Surface and SLIPS

Superhydrophobic Surface was fabricated by etching the aluminum sample in a 2 mol/1 hydrochloric acid solution for 40 minutes, followed by the ultrasonic cleaning in deionized water for 2 minutes. To render it superhydrophobic, the etched aluminum was first modified by immersion in a 1 mM ethanol solution of 1H,1H,2H,2H-perfluorodecyltrichlorosilane for 2 hours, and subsequently heated at 100° C. in air for 30 minutes. To prepare the SLIPS, the superhydrophobic surface was fully infused with the FC-70 oil. The excess oil was drained for 30 minutes via gravity.

Topography characterization Functional PTFE and silica particles in the colloids were imaged by using a transmission electron microscopy (Philips CM100). The topography of PTFE particles and the superhydrophobic surface were characterized using a scanning electron microscopy (Hitachi S4800). The roughness factors of various smooth surfaces, superhydrophobic surface, and PTFE particle surfaces were determined by a laser profilometer (Bruker ContourGT-K1).

Wettability and Repellency Measurements

Contact angles of various fluid and colloid droplets (˜5 μl) on untreated and silylated aluminum surfaces, flat PTFE surface, flat silica surface, and superhydrophobic surface were measured with a contact angle goniometer (Dataphysics OCA 25) at ambient conditions (22° C.-25° C.). To measure sliding angles, CISS surfaces were tilted with respect to the horizontal plane until the fluid droplets or viscoelastic peanut butter (˜5 μl) start to slide along the surfaces. After recording the sliding behaviors of different fluid droplets, the advancing and receding contact angles of these fluids on the CISS were measured by the OCA 25 goniometer. The contact angle hysteresis was calculated by subtracting the receding contact angle by the advancing contact angle. The surface tensions of the colloids and FC-70 oil were evaluated using a dynamic contact angle tensiometer (Dataphysics DACT 25) by the Wilhelmy plate method. The interfacial tensions between the FC-70 and various fluids were measured based on the pendant droplet method at ambient conditions by using the OCA 25 goniometer.

Dynamic Viscosity Measurement

The dynamic viscosities of the FC-70 oil and various colloids were measured by a viscometer (Brookfield DV-II+ Pro) equipped with a CPE-42 spindle. The dynamic viscosities of honey, tomato ketchup, toothpaste, and peanut butter were measured by a rheometer (Brookfield R/S) at a set speed of 0.1 rpm.

Droplet Impact Test

To investigate the stability of CISS, continuous droplet impact test was performed on three surfaces, including CISS, SLIPS, and smooth surface infused by the FC-70 oil. These surfaces were tilted at an angle of about 10°, and were continuously impacted by falling water droplets (˜25 μl) from a specific height of 10 cm. The falling rate of water droplets was controlled by a syringe pump (LongerPump LSP01-2A). The droplet impacting behavior was captured by a high-speed camera (iX Cameras, iSpeed 510) at a frame rate of 5000 fps. The stabilities of these surfaces were evaluated by varying the sliding angle after the droplet impact.

Bubble Repellency Test

Bubble repellency tests were carried out under deionized water at a depth of about 1 cm. Air bubbles (˜30 μl) were generated release from a pipette on the smooth surface and CISS surface, both of which were inclined at about 2.5°. The sliding processes of air bubbles on these surfaces were captured by the high-speed camera (iX Cameras, iSpeed 510).

Ice Repellency Test

Ice repellency tests were performed on CISS and smooth surfaces using a precisely controlled cooling device (Dataphysics TC 160Pro). Blue water droplets (˜25 μl) dyed by methylene blue were released on the CISS and smooth surfaces, which were placed on the horizontal cooling stage at a set temperature of −5° C. After cooling for about 1 minute, the cooling stage was tilted at an angle of ˜10°. The sliding behaviors of droplets on two surfaces were recorded by a digital camera (Canon EOS 600D).

Evaporation Test

The evaporation rate of three colloids synthesized by the FC-70, Krytox™ GPL 101 and Krytox™ GPL 103 oils were evaluated for thirty consecutive days in an open area at a relative humidity 50%-60% and a temperature of 22° C.-25° C. During these days, the mass of each CISS sample was monitored by a high-resolution balance (KERN AEJ 200-5CM) with a sensitivity of 0.1 mg, and the sliding angle of water droplet (˜5 μl) on each CISS sample was measured by the contact angle goniometer (Dataphysics OCA 25).

Dissipative Force Measurement

The dissipative force acting on a moving droplet on the CISS was measured by a built cantilever force sensor consisting of a capillary glass tube with a typical length of 8 cm, an inner diameter of 0.1 mm, and an outer diameter of 0.32 mm. The moving speed of the underlying CISS sample was precisely controlled by a motor stage (Aerotech PlanarDL-200XY). The deflection of capillary tube was optically captured by the high-speed camera (iX Cameras, iSpeed 510).

Adhesion Test and Visualization

Tomato ketchup, honey and yogurt samples were used to examine the adhesion of slippery and smooth glass vials. Each ˜40 ml sample was put into a slippery or smooth glass 50 ml vial, and the samples were poured out while optically recording the pour with a digital camera (Canon EOS 600D). The mass losses of the food from the vials were monitored by a high-resolution balance (KERN AEJ 200-5CM).

Slippery Catheter Test

A PTFE catheter with an inner diameter of 0.5 mm and an outer diameter of 0.9 mm was used to create a slippery CISS catheter. The sliding behaviors of mineral oil droplets stained by the oil red O on and inside the tilted slippery or smooth catheters (tilting angle ˜5°) were captured by the high-speed camera (iX Cameras, iSpeed 510).

All publications referred to or cited herein are incorporated by reference in their entirety, including all figures and tables, to the extent they are not inconsistent with the explicit teachings of this specification.

### REFERENCES

Wong, T. S., Kang, S. H., Tang, S. K. Y., Smythe, E. J., Hatton, B. D., Grinthal, A. & Aizenberg, J. Bioinspired self-repairing slippery surfaces with pressure-stable omniphobicity. Nature 477, 443-447(2011).
Lafuma, A. & Quéré, D. Slippery pre-suffused surfaces. Europhys. Lett. 96, 56001(2011).
Irajizad, P., Hasnain, M., Farokhnia, N., Sajadi, S. M. & Ghasemi, H. Magnetic slippery extreme icephobic surfaces. Nat. Commun. 7, 13395(2016).
Kim, P., Wong, T. S., Alvarenga, J., Kreder, M. J., Adorno-Martinez, W. E. & Aizenberg, J. Liquid-infused nanostructured surfaces with extreme anti-ice and anti-frost performance. ACS Nano 6, 6569-6577(2012).
Kreder, M. J., Alvarenga, J., Kim, P. & Aizenberg, J. Design of anti-icing surfaces: Smooth, textured or slippery? Nat. Rev. Mater. 1, 15003(2016).
Epstein, A. K., Wong, T. S., Belisle, R. A., Boggs, E. M. & Aizenberg, J. Liquid-infused structured surfaces with exceptional anti-biofouling performance. Proc. Natl. Acad. Sci. U.S.A 109, 13182-13187(2012).
Leslie, D. C., Waterhouse, A., Berthet, J. B., Valentin, T. M., Watters, A. L., Jain, A., Kim, P., Hatton, B. D., Nedder, A., Donovan, K., Super, E. H., Howell, C., Johnson, C. P., Vu, T. L., Bolgen, D. E., Rifai, S., Hansen, A. R., Aizenberg, M., Super, M., Aizenberg, J. & Ingber, D. E. A bioinspired omniphobic surface coating on medical devices prevents thrombosis and biofouling. Nat. Biotechnol. 32, 1134-1140(2014).
Amini, S., Kolle, S., Petrone, L., Ahanotu, O., Sunny, S., Sutanto, C. N., Hoon, S., Cohen, L., Weaver, J. C., Aizenberg, J., Vogel, N. & Miserez, A. Preventing mussel adhesion using lubricant-infused materials. Science 357, 668-673(2017).
Badv, M., Imani, S. M., Weitz, J. I. & Didar, T. F. Lubricant-infused surfaces with built-in functional biomolecules exhibit simultaneous repellency and tunable cell adhesion. ACS Nano 12, 10890-10902(2018).
Han, X., Li, W., Zhao, H., Li, J., Tang, X. & Wang, L. Slippery damper of an overlay for arresting and manipulating droplets on nonwetting surfaces. Nat. Commun. 12, 3154(2021).
Jiang, J., Gao, J., Zhang, H., He, W., Zhang, J., Daniel, D. & Yao, X. Directional pumping of water and oil microdroplets on slippery surface. Proc. Natl. Acad. Sci. U.S.A 116, 2482(2019).
Dai, X., Sun, N., Nielsen, S. O., Stogin, B. B., Wang, J., Yang, S. & Wong, T. S. Hydrophilic directional slippery rough surfaces for water harvesting. Sci. Adv. 4, eaaq0919(2018).
Li, J., Li, W., Tang, X., Han, X. & Wang, L. Lubricant-mediated strong droplet adhesion on lubricant-impregnated surfaces. Langmuir 37, 8607-8615(2021).
Cho, H. J., Preston, D. J., Zhu, Y. & Wang, E. N. Nanoengineered materials for liquid-vapour phase-change heat transfer. Nat. Rev. Mater. 2, 16092(2016).
Peppou-Chapman, S., Hong, J. K., Waterhouse, A. & Neto, C. Life and death of liquid-infused surfaces: A review on the choice, analysis and fate of the infused liquid layer. Chem. Soc. Rev. 49, 3688-3715(2020).
Villegas, M., Zhang, Y., Abu Jarad, N., Soleymani, L. & Didar, T. F. Liquid-infused surfaces: A review of theory, design, and applications. ACS Nano 13, 8517-8536(2019).
Wu, Y., Zhou, S., You, B. & Wu, L. Bioinspired design of three-dimensional ordered tribrachia-post arrays with re-entrant geometry for omniphobic and slippery surfaces. ACS Nano 11, 8265-8272(2017).
Tenjimbayashi, M., Togasawa, R., Manabe, K., Matsubayashi, T., Moriya, T., Komine, M. & Shiratori, S. Liquid-infused smooth coating with transparency, super-durability, and extraordinary hydrophobicity. Adv. Funct. Mater. 26, 6693-6702(2016).
Barthlott, W. & Neinhuis, C. Purity of the sacred lotus, or escape from contamination in biological surfaces. Planta 202, 1-8(1997).
Bohn, H. F. & Federle, W. Insect aquaplaning: Nepenthes pitcher plants capture prey with the peristome, a fully wettable water-lubricated anisotropic surface. Proc. Natl. Acad. Sci. U.S.A. 101, 14138-14143(2004).
Quéré, D. Wetting and roughness. Annu. Rev. Mater. Res. 38, 71-99(2008).
John, T. S., Scott, R. H. & Tolga, A. Superhydrophobic materials and coatings: A review. Rep. Prog. Phys. 78, 086501(2015).
Wang, J., Wang, L., Sun, N., Tierney, R., Li, H., Corsetti, M., Williams, L., Wong, P. K. & Wong, T. S. Viscoelastic solid-repellent coatings for extreme water saving and global sanitation. Nat. Sustain. 2, 1097-1105(2019).
Dhyani, A., Wang, J., Halvey, A. K., Macdonald, B., Mehta, G. & Tuteja, A. Design and applications of surfaces that control the accretion of matter. Science 373, eaba5010(2021).
Extrand, C. W. Origins of wetting. Langmuir 32, 7697-7706(2016).
Girifalco, L. A. & Good, R. J. A theory for the estimation of surface and interfacial energies. I. Derivation and application to interfacial tension. J. Phys. Chem. 61, 904-909(1957).
Daniel, D., Timonen, J. V. I., Li, R. P., Yelling, S. J. & Aizenberg, J. Oleoplaning droplets on lubricated surfaces. Nat. Phys. 13, 1020-1025(2017).
Daniel, D., Timonen, J. V. I., Li, R., Yelling, S. J., Kreder, M. J., Tetreault, A. & Aizenberg, J. Origins of extreme liquid repellency on structured, flat, and lubricated hydrophobic surfaces. Phys. Rev. Lett. 120, 244503(2018).
't Mannetje, D., Banpurkar, A., Koppelman, H., Duits, M. H. G., van den Ende, D. & Mugele, F. Electrically tunable wetting defects characterized by a simple capillary force sensor. Langmuir 29, 9944-9949(2013).
Lagubeau, G., Le Merrer, M., Clanet, C. & Quéré, D. Leidenfrost on a ratchet. Nat. Phys. 7, 395-398(2011).
Halpern, A. The surface tension of oils. I Phys. Chem. 53, 895-897(1949).
Rezayi, T., Entezari, M. H. & Moosavi, F. The variation of surface free energy of al during superhydrophobicity processing. Chem. Eng. J. 322, 181-187(2017).
Saifaldeen, Z. S., Khedir, K. R., Camci, M. T., Ucar, A., Suzer, S. & Karabacak, T. The effect of polar end of long-chain fluorocarbon oligomers in promoting the superamphiphobic property over multi-scale rough al alloy surfaces. Appl. Surf Sci. 379, 55-65(2016).
Daniel, D., Timonen, J. V. I., Li, R., Velling, S. J., Kreder, M. J., Tetreault, A. & Aizenberg, J. Origins of extreme liquid repellency on structured, flat, and lubricated hydrophobic surfaces. Phys. Rev. Lett. 120, 244503(2018).
Daniel, D., Timonen, J. V. I., Li, R. P., Velling, S. J. & Aizenberg, J. Oleoplaning droplets on lubricated surfaces. Nat. Phys. 13, 1020-1025(2017).

1. A colloid-infused smooth surface (CISS) device comprising:
a solid substrate with a smooth surface; and
a coating comprising:
a non-volatile lubricating fluid; and
a plurality of nanoparticles and/or microparticles.

2. The CISS device according to claim 1, wherein the non-volatile lubricating fluid comprises a perfluorinated fluid.

3. The CISS device according to claim 2, wherein the perfluorinated fluid is selected from FC-70 and Chemours™ Krytox™ oils.

4. The CISS device according to claim 1, wherein the nanoparticles and/or microparticles comprise polytetrafluoroethylene (PTFE).

5. The CISS device according to claim 1, wherein the nanoparticles and/or microparticles are 0.01 to 0.06 mass fraction of the coating.

6. The CISS device according to claim 1, wherein the solid substrate comprises a metal, ceramic, glass, or plastic.

7. The CISS device according to claim 1, wherein the smooth surface has a roughness factors from 1.00 to 1.45.

8. The CISS device according to claim 1, wherein the smooth surface is silylated with a silylating agent missible with the non-volatile lubricating fluid.

9. The CISS device according to claim 8, wherein the lubricating fluid is selected from FC-70 and Chemours™ Krytox™ oils and the silylating agent is 1H,1H,2H,2H-perfluorodecyltrichlorosilane.

10. The CISS device according to claim 8, wherein the non-volatile lubricating fluid is a silicone oil and the nanoparticles and/or microparticles comprise silica particle.

11. The CISS device according to claim 8, wherein the non-volatile lubricating fluid is a hydrocarbon oil and the nanoparticles and/or microparticles comprise waxes, polyethylene, or alkyl functionalized silica particle.

12. A method of forming a solid device comprising a CISS that repels gases, liquids, and solids, comprising:
providing a solid object with a smooth surface; and
coating the smooth surface with a colloidal suspension comprising:
a non-volatile lubricating fluid; and
a plurality of nanoparticles and/or microparticles.

13. The method according to claim 12, wherein the solid object comprises a metal, ceramic, glass, or plastic.

14. The method according to claim 12, wherein coating comprises dip coating, roll coating, or spraying.

15. The method according to claim 12, wherein the non-volatile lubricating fluid comprises a perfluorinated fluid.

16. The method according to claim 15, wherein the perfluorinated fluid is selected from FC-70 and Chemours™ Krytox™ oils.

17. The method according to claim 12, wherein the nanoparticles and/or microparticles comprise PTFE.

18. The method according to claim 12, wherein the nanoparticles and/or microparticles are 0.01 to 0.06 mass fraction of the colloidal suspension.

19. The method according to claim 12, wherein the solid device is a tube, a vial, or a bottle.

20. The method according to claim 12, further comprising silylatating the solid object with a smooth surface with a silylating agent missible with the lubricating fluid.

21. The method according to claim 20, wherein the perfluorinated fluid is selected from FC-70 and Chemours™ Krytox™ oils and the silylating agent is 1H,1H,2H,2H-perfluorodecyltrichlorosilane.

22. The method according to claim 12, wherein the CISS repels hydrocarbons, mineral oil, water, ethanol, silicone oils, glycerol, ethylene glycol, dimethylformamide, honey, ketchup, toothpaste, and peanut butter.

23. A self-healing omniphobic device, comprising a CISS according to claim 1.
